(19) United States
(12) Patent Application Publication
(10) Pub. No.: US 2013/0262192 A1
(43) Pub. Date: Oct. 3, 2013

(54) SYSTEM AND METHOD FOR RECEIVING QUALITY ISSUE LOG

(71) Applicants: Joel McCarty, Edmond, OK (US); David Miyatake, Savannah, TX (US)

(72) Inventors: Joel McCarty, Edmond, OK (US); David Miyatake, Savannah, TX (US)

(73) Assignee: ATC Logistics & Electronics

(21) Appl. No.: 13/434,507

(22) Filed: Mar. 29, 2012

(51) Int. Cl. G06Q 10/06

(52) U.S. Cl. CPC G06Q 10/06395
USPC 705/7.41

(57) ABSTRACT

A system and computer implemented method for managing quality processing of electronic devices. A number of electronic devices are received for processing. The number of electronic devices are randomly sampled utilizing sampling thresholds to determine issues with the number of electronic devices. The sampling thresholds are automatically adjusted in real-time in response to results of the sampling. Failure processing is implemented in response to one or more of the number of electronic devices failing the sampling. The information associated with the processing of the number of electronic devices in recorded in one or more databases.

### CROSS-REFERENCE TO RELATED APPLICATIONS

The following applications including the described, systems, methods, and devices may be utilized with the illustrative embodiments including U.S. patent application Ser. No. 12/940,299 filed Nov. 5, 2010 entitled SYSTEM AND METHOD FOR TRACKING CUSTOMER PERSONAL INFORMATION IN A WAREHOUSE MANAGEMENT SYSTEM, which is a co-pending application of U.S. patent application Ser. No. 12/940,411, filed Nov. 5, 2010 entitled “SYSTEM AND METHOD FOR FLASHING A WIRELESS DEVICE”; Ser. No. 12/940,331, filed Nov. 5, 2010 entitled “SYSTEM AND METHOD FOR REMOVING CUSTOMER PERSONAL INFORMATION FROM AN ELECTRONIC DEVICE”, Ser. No. 12/940,346, filed Nov. 5, 2010 entitled “SYSTEM AND METHOD FOR AUDITING REMOVAL OF CUSTOMER PERSONAL INFORMATION ON ELECTRONIC DEVICES”, Ser. No. 12/613,293 filed Nov. 5, 2009 entitled “RF TEST FIXTURE AND METHOD FOR SECURING A WIRELESS DEVICE FOR RF TESTING”, Ser. No. 12/613,324 filed Nov. 5, 2009 entitled “MULTIDIMENSIONAL RF TEST FIXTURE AND METHOD FOR SECURING A WIRELESS DEVICE FOR RF TESTING”, which were previously filed and the teachings and disclosures of which are hereby incorporated in their entireties by reference thereto.

### BACKGROUND

Usage of mobile, wireless, and electronic devices has grown nearly exponentially in recent years. The expanded use of such products and devices has been fostered by improvements in communications standards, protocols, signaling, hardware, software, and other advances. Under various circumstances, users may return electronic devices to an original equipment manufacturer (OEM), retailer, repair facility, service provider, or other entity. Electronic devices are often returned for repairs, exchanges, warranty issues, or any number of other justified or arbitrary reasons. It is imperative that any electronic device that has been returned be cleared of all personal information, sensitive data, or other information linked to a previous user. If the personal information is not removed, applicable laws, industry standards, and common business practices may be violated. For example, the personal information may be used by another party to perpetrate an act of identity theft. Similarly, a previous user's privacy may be otherwise violated.

It is important to document quality issues regarding the processing of electronic devices. Many current systems typically require multiple systems to manually updated, manage, and report information as the electronic devices are processed. For example, data entry may be duplicated across multiple systems, resulting in significant labor and computing costs.

### SUMMARY

One embodiment includes a system and computer implemented method for managing quality processing of electronic devices. A number of electronic devices may be received for processing. The number of electronic devices may be randomly sampled utilizing sampling thresholds to determine issues with the number of electronic devices. The sampling thresholds may be automatically adjusted in real-time in response to results of the sampling. Failure processing may be implemented in response to one or more of the number of electronic devices failing the sampling. The information associated with the processing of the number of electronic devices may be recorded in one or more databases.

Another embodiment includes a system for managing quality processing of electronic devices. The system may include one or more client devices configured to receive information for a number of electronic devices for processing. The system may also include a server configured to create tickets for each of the plurality of electronic devices, manage random sampling of the plurality of electronic devices utilizing sampling thresholds, automatically adjust the sampling thresholds in real-time in response to results of the sampling, and implement failure processing in response to one or more of the plurality of electronic devices failing the sampling. The system may also include a database in communication with the server. The database may be configured to store the information associated with each of the tickets for each of the plurality of electronic devices.

Yet another embodiment includes a server. The server may include a processor for executing a set of instructions and a memory for storing the set of instructions. The set of instructions may be configured to receive a number of electronic devices for processing, generate one or more tickets for the number of electronic devices, randomly sample the number of electronic devices utilizing sampling thresholds to determine issues with the number of electronic devices; automatically adjust the sampling thresholds in real-time in response to results of the sampling, implement failure processing in response to one or more of the plurality of electronic devices failing the sampling, and record the one or more tickets including information associated with the processing of the plurality of electronic devices in one or more databases.

### BRIEF DESCRIPTION OF THE DRAWINGS

Illustrative embodiments of the present invention are described in detail below with reference to the attached drawing figures, which are incorporated by reference herein and wherein:

FIG. 1 is a pictorial representation of a computing network in accordance with an illustrative embodiment;

FIG. 2 is a block diagram of an RQIL system in accordance with an illustrative embodiment;

FIG. 3 is a pictorial representation of RQIL processing in accordance with an illustrative embodiment;

FIG. 4 is a flowchart of a process for ticket management in accordance with an illustrative embodiment;

FIG. 5 is a is a flowchart of a process for implementing quality control in accordance with an illustrative embodiment;

FIG. 6 is a state diagram of a sampling rate in accordance with an illustrative embodiment;

FIG. 7 is a pictorial representation of an interface of the RQIL system in accordance with an illustrative embodiment; and

FIG. 8 is a block diagram of modules of the RQIL system 800 in accordance with an illustrative embodiment.

### DETAILED DESCRIPTION OF THE DRAWINGS

Illustrative embodiments provide a system, computer program product, and method for automating workflows for managing quality processing or electronic devices. In one embodiment, the workflows may be utilized to mirror production processes. The system may include multiple computing or communications devices executing, or accessing a program for tracking and managing quality control issues in a distributed, networked, and/or stand-alone configuration.

In one embodiment, the system and program is a receiving quality issue log (RQIL) system and program. In one embodiment, the RQIL system is an online workflow driven system designed to track quality issues from an initial discovery for electronic devices through final changes that are initiated based on an outcome of root cause analysis. The issues may be discovered by sampling products randomly, in patterns, or in predefined configurations. For example, the RQIL system may be accessible via a secure website. The RQIL system may be particularly beneficial to suppliers that are presented options to update tickets assigned to their organization rather than relying on e-mail or other informal communication.

In addition, suppliers, service providers, and other parties may receive receiving quality issue logs (RQIL), discrepancy reports, lot failure information, fallout, and buyback details from a single system. The parties accessing the system, including suppliers, may be able to do so in real-time or on-demand. The RQIL system ensures that the customer is shielded from seeing confidential or internal process information. The sampling thresholds and failure thresholds (rates) maybe adjusted in real-time in response to testing results. The thresholds may include business rules set by any number of parties that may adjust the thresholds. As a result, manual access to databases and spreadsheets is eliminated and labor costs are reduced significantly.

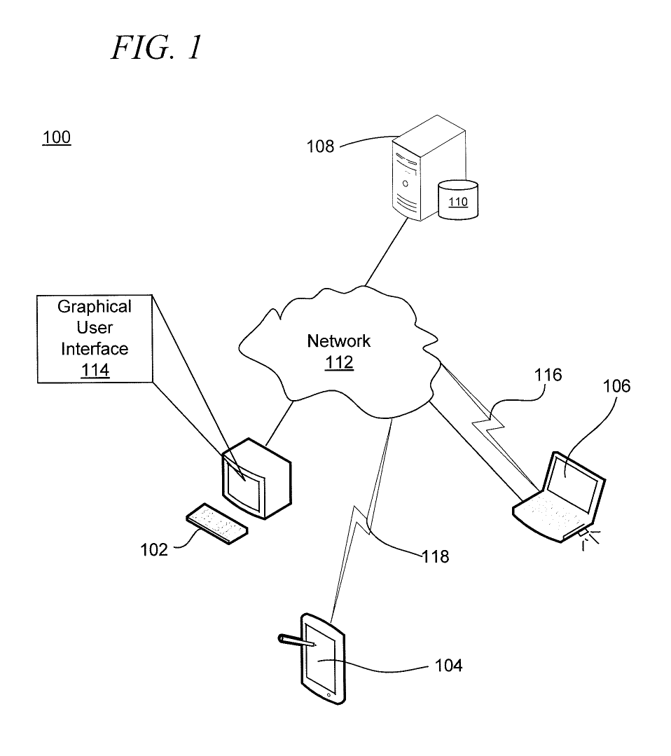

FIG. 1 is a pictorial representation of a computing network 100 in accordance with an illustrative embodiment. The computing network 100 of FIG. 1 may include any number of electronic and communications devices, systems, and equipment. The computing network 100 may represent client-server relationships of the devices and/or a distributed computing environment.

In one embodiment, the computing network 100 includes a client 102, a wireless device 104, a laptop 106, a server 108 a database 110, a network 112, a graphical user interface 114, and wireless signals 116 and 118. The computing network 100 may represent a network or system utilized by a service provider, OEM, logistics provider, organization, or other entity for processing electronic devices us, such as cell phones, MP3 players, tablet computing devices, laptops, PDAs, etc.

The client 102, wireless device 104, laptop 106, and server 108 represent computing and communications devices. The client 102, wireless device 104, laptop 106, and server 108 may include any number of input/output devices, visual and voice interfaces, and peripherals for displaying and receiving user input. For example, any of the computing or communications devices may additionally include a scanner for scanning a serial number, barcode, or other identifier of an electronic device. In addition, the computing or communications devices may also include interfaces for connecting to the electronic devices to perform any number of tests or inspections, such as radio frequency, CPI, or functional testing.

In one embodiment, a specialized application, program, or instructions may be executed by any of the computing or communications devices of the computing network 100. For example, the specialized application may be the RQIL application utilized for tracking and processing electronic devices in a distributed computing environment. For example, the electronic devices may be new, repaired, damaged, refurbished, upgraded, or returned. In another embodiment, the RQIL application may be stored and executed by the server 108. The client 102, wireless device 104, and laptop 106 may access the RQIL application through the network 112.

The network 112 is a communications network, enabling various computing and communications devices to communicate. In one embodiment, the network 112 is an Ethernet network. However, the network 112 may be a wireless network, cellular network, or other wired or wireless network. In one embodiment, the network 112 is a private network utilized by an organization processing electronic devices. The network 112 may communicate with any number of other public or private networks, such as the Internet.

Each of the client 102, wireless device 104, laptop 106, and server 108 may include electronic components known in the art for both executing and storing the RQIL application, such as one or more processors and memories. The processor is circuitry or logic enabled to control execution of a set of instructions. The processor may be microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements.

The memory is a hardware element, device, or recording media configured to store data for subsequent retrieval or access at a later time. The memory may be static or dynamic memory. The memory may include a hard disk, random access memory, cache, removable media drive, mass storage, or configuration suitable as storage for data, instructions, and information. In one embodiment, the memory and processor may be integrated. The memory may use any type of volatile or non-volatile storage techniques and mediums known in the art.

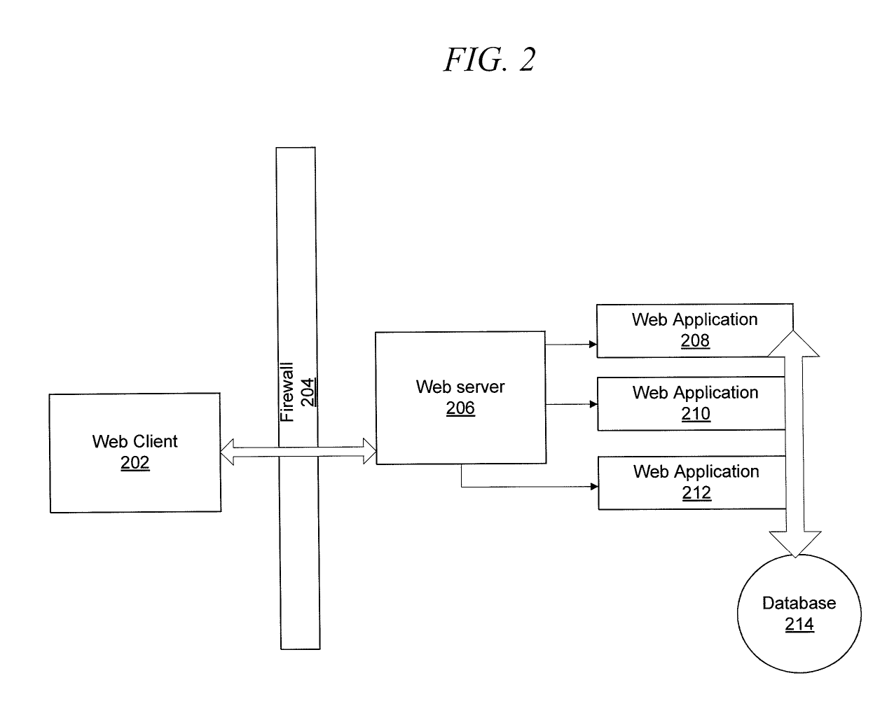

FIG. 2 is a block diagram of an RQIL system 200 in accordance with an illustrative embodiment. In one embodiment, the RQIL system 200 may be implemented in the computing network 100 of FIG. 1. The components of FIG. 2 may represent any number of software modules, instructions, or client-server components.

In one embodiment, the RQIL system 200 includes a web client 202, a firewall 204, a web server 206, web applications 208-212, and a database 214. The components of the RQIL system 200 may communicate utilizing network connections, links, buses, wires, traces, or other communications elements.

The web client 202 is an application that accesses services made available by the web server 206. The web client 202 is representative of any number of clients that may access the web server 206. The firewall 204 is a barrier designed to prevent unauthorized communications from the web client 202, or other applications, devices, or systems. Various forms of authentication may be also used to create a secure connection between the web client 202 and the web server 206. In addition to the firewall, the secure connection may be a virtual private network tunnel, an SSL encrypted web session, require a username/password, or utilize any number of other forms of secured communications. Communications between the web client 202 and the web server 206 may you utilize HTML, CSS AJAX, etc.

The web applications 208-212 may include any number of plug-ins or modules, such as active server pages (ASP), PHP, and Java/JSP. The database 214 is an organized collection of data for access by the web applications 208-212 utilized by the web server 206. In particular, the database 214 may store information associated with electronic devices, batches, operators, product shipments, tickets, discrepancies, suppliers, service providers, status, applicable date, return merchandise authorization, root cause information, as well as other files, data, and information. The Web server 206 may include a database management system (DBMS), such as SQL for creating, storing, querying, accessing, and otherwise managing records. However, the DBMS may be any system suitable for database management as is known in the art.

In one embodiment, the RQIL system 200 may be integrated with, or include a warehouse management system (WMS). The WMS may be utilized to process transactions, including shipping, receiving, testing, putaway, picking, distribution, and reporting.

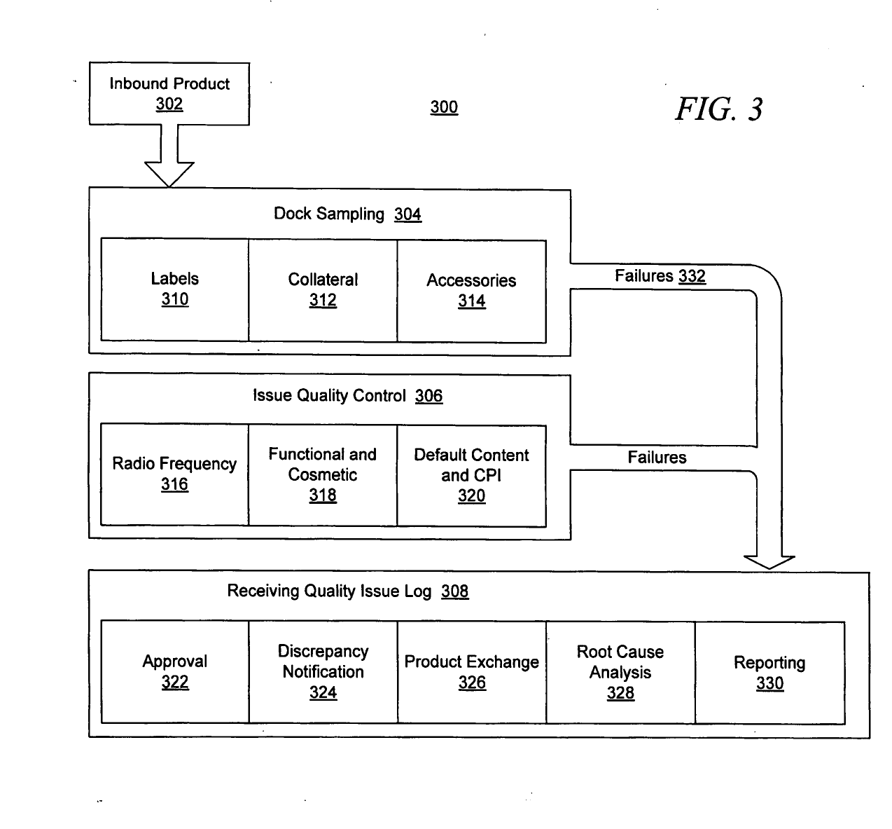

FIG. 3 is a pictorial representation of RQIL processing 300 in accordance with an illustrative embodiment. The RQIL processing 300 may include various key steps for processing including receiving an inbound product 302, dock sampling 304, issue quality control 306, and receiving quality issue log 308. The RQIL processing 300 may be performed by the RQIL system 200 of FIG. 2 or other similar systems.

Dock sampling 304 may represent receipt of the inbound product 302. In one embodiment, dock sampling 304 includes labels 310, collateral 312, and accessories 314. During the dock sampling 304 the inbound products 302 may be received, identified, and sorted. Dock sampling 304 may include scanning the labels 310, such as barcodes, RFID tags, or serial numbers for individual devices, shipments, or batches. The same may be performed for the accessories 314 of the electronic devices. During dock sampling 304 or subsequently, an administrator or other operator may distribute all or portions

The issue quality control 306 may include sampling or testing individual, lots, or batches of electronic devices. Sampling may include tests, such as radio frequency 316, functional and cosmetic 318, and default content and consumer private information (CPI) 320. During the issue quality control 306 any number of testing systems, devices, systems, applications, and equipment may be utilized. In one embodiment, the issue quality control 306 ensures that the electronic device is suitable for its intended purpose, as fully functional, includes updated operating systems, applications, and firmware, is cosmetically sound, includes default content, does not include consumer private information, and otherwise complies with processing requirements and procedures, industry standards, and applicable laws.

The receiving quality issue log 308 may similarly include any number of processes and steps, such as approval 322, discrepancy notification 324, product exchange 326, root cause analysis 328, and reporting 330. Approval 322 may be automated in the form of computing logic used to perform validation relating to a particular product or lot of products during the lifecycle of an issue or determine that human intervention is required. In the case where human intervention is required from an employee, supplier, or customer, the application provides an automated notification and workflow cycle that requests approval from the appropriate persons and roles, records the results and automatically advances associated tickets through the appropriate steps based on an approval response.

In each of the aforementioned steps, the RQIL processing 200 manages initial automated alerts and configurable escalation thresholds to ensure appropriate persons are (re)notified until such time as an appropriate response has been received.

At any time, failures 332 may be noted or ticketed for reporting 330. For example, an email indicating the electronic device information, lot information, and failure information may be sent to individuals or addresses included on a distribution list. Failures 332 may indicate the type of product that failed (e.g. material, catastrophic, related to product safety, etc), status of the electronic device (e.g. new, used, repaired, refurbished, etc), tests performed, involved parties (manufacturer, supplier, logistics provider, etc), part of the electronic device that failed if known,

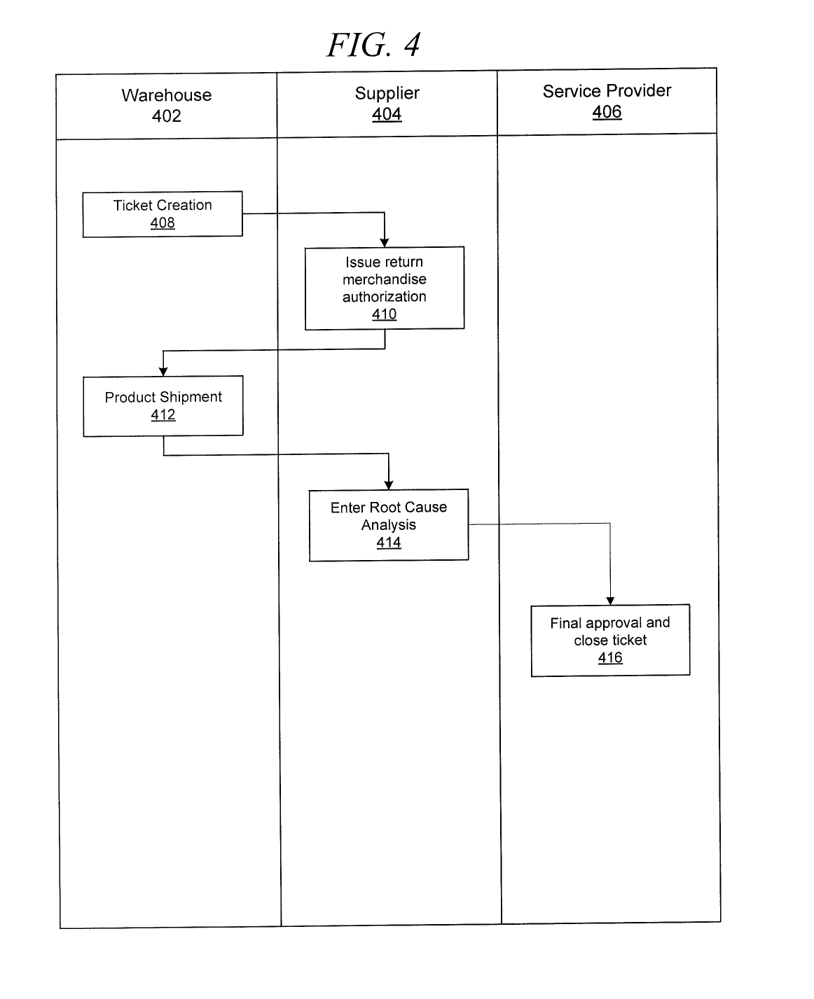

FIG. 4 is a flowchart of a process for ticket management in accordance with an illustrative embodiment. The process of FIG. 4 may be implemented utilizing the RQIL system and processes as are herein described. Responsibilities and process steps through each stage/phase and may be shared by a warehouse 402, a supplier 404, and a service provider 406.

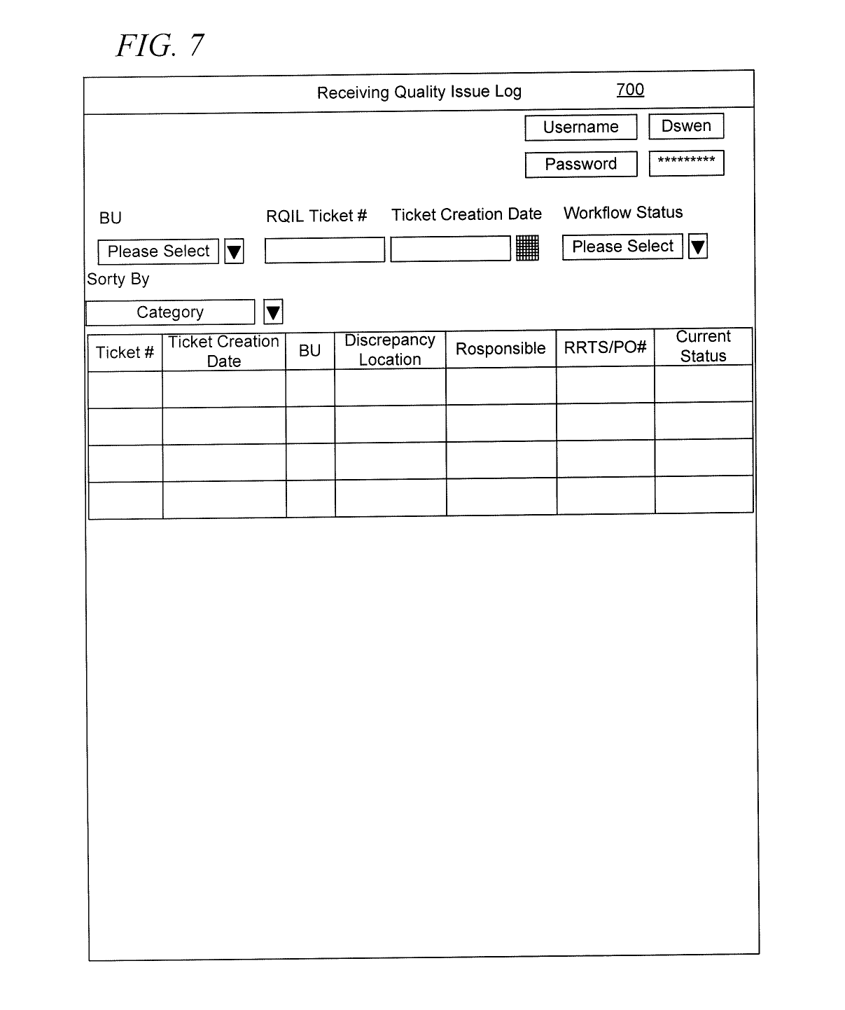

The process of FIG. 4 may begin with the warehouse 402 creating a ticket (step 408). The RQIL system may provide windows or interface pages of a graphical user interface, displayable to a browser, that allow users from the warehouse 402, supplier 404, or service provider to enter information, view associated tickets, and manage roles, users, notifications, distribution lists, templates, and other applicable features of the RQIL system. In one embodiment, a user may select to view tickets from a tickets menu. A database or table view of all of the tickets associated with the supplier may be displayed by the graphical user interface. For example, the graphical user interface may display ticket number, a ticket creation date, a BU, a discrepancy location, a responsible party, an RTS/PO#, a current status and a workflow status (see FIG. 7).

The ticket information may include hyperlinks that allow the user to access additional ticket details. The additional ticket details may include fields or information, such as a business unit, an original equipment manufacturer (OEM), a supplier/Alpha code, an SKU, a model of the electronic device, a truck number, a number of pallets, a lot peace quantity, a sampling size, a failure number, and a quantity returned. For electronic devices that have been sampled the graphical user interface may further indicate an identifier, and indicated trouble, an IMEI, a field for additional troubles, a name of the quality control inspector, a name of a verifying party, a supervisor, and party submitting the ticket, any associated files, and notes regarding discrepancies or other details.

Next, the supplier 404 issues a return merchandise authorization (RMA) (step 410). The RMA may be submitted for a single ticket or in multiples (for efficiency if several tickets needs to be updated at once). In one embodiment, step 410 may only be required for discrepancies that include a returned product. In one embodiment, the supplier 404 may issue multiple RMAs per lot, if necessary. The supplier 404 may be able to provide RMA details, such as RMA number, RMA issue date, unit price, credit amount, and credit memo number. As previously described, RMAs for several tickets may be updated at once in response to a user selection. The RQIL system provides the flexibility of attaching multiple RMAs to specific pieces of the same lot. For example, each piece on the return may be displayed to the user for assigning specific RMAs to individual pieces.

Next, the warehouse 402 receives a product shipment (step 412). The product shipment may be scanned in automatically utilizing any number of scanning devices or manually entered information.

The supplier 404 enters a root cause analysis (step 414). In one embodiment, root cause information may be required for each ticket. For example, some logistics providers may require containment actions to be provided soon as a ticket is issued with additional root cause analysis information being required within 30 days. In one embodiment, the root cause information may be received by a user selecting an individual ticket. A list of potential IMEIs may be displayed, once selected, the root cause information may be entered. For example, the root cause information fields may include a primary failure cause, a detailed description of root cause, remedial actions, containment actions, corrective/preventive actions, other implementations, and an associated file.

The primary failure cause may identify a component and/or process that failed. The detailed description of root cause may provide details describing the component that failed (if applicable) and why the process failed in detecting the issue. The remedial actions may describe what actions were taken to immediately resolve the issue. The containment actions may describe what actions were taken to prevent any future occurrence of the issue. The corrective/preventive actions may describe what permanent changes were made to the product design (if applicable) and processes in order to prevent the issue from reoccurring. Other implementations may provide any additional information that was not already expressed in the previous fields. The user may also attach a file that is displayed as a link to any documents, as pictures, or video associated with any of the root cause information.

The RQIL system may allow a user to copy information from one IMEI to another when the IMEIs share root cause information. Once information is copied from one IMEI to another, the root cause information may be synchronized and future updates to the “parent” IMEI.

Notifications may be sent out every time an update is made to a ticket. In one embodiment, the subject line of the notification may include a ticket status, a ticket number, date of update, a PO number, an SKU, and a supplier. The body of the notification may include high-level ticket information. In addition to a link to the ticket available through the RQIL system and web interface. The supplier 404 may manage notifications for each workflow stage utilizing user preferences for managing notifications. The RQIL system may allow the supplier 4042 update the permissions and automatic notifications. For example, the supplier may specify a name and e-mail address of an authorized user. Distribution lists may also be managed by the supplier to specify which users receive notifications for certain events. The supplier may also assign distribution list for notification when a ticket enters a specific workflow stage.

The supplier 404 may also assign users and roles for the RQIL system. Roles are collections of permissions that are assigned to one or more users to specify what actions the users may perform on the system. For example, an administrator may update the roles of other users. User names, identifications, and passwords may also be assigned to individual users.

Next, the service provider 406 gives final approval and closes the ticket (step 416) In the case that the service provider does not deem one or more requirements of the root causes analysis is satisfied, the ticket is rejected with appropriate comments so that the ticket is sent through a review and approval cycle until final approval is reached.

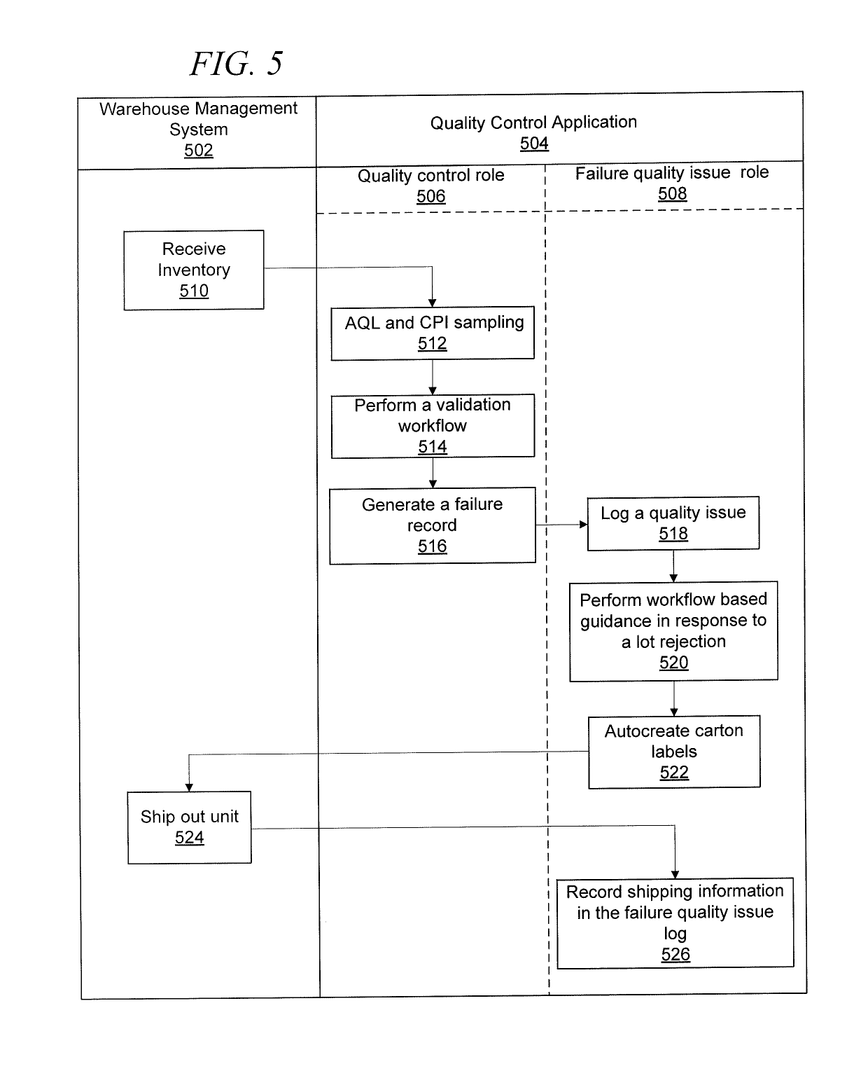

FIG. 5 is a flowchart of a process for implementing quality control in accordance with an illustrative embodiment. In one embodiment, the process of FIG. 5 may be implemented by a warehouse management system 502 and a quality control application 504. The warehouse management system 502 and the quality control application 504 may represent distinct or integrated applications. In one embodiment, a client device may be utilized to execute or access the warehouse management system 502 and the quality control application 504. However, any number of devices or systems may be utilized to access, manage, and interact with the warehouse management system 502 and the quality control application 504. The quality control application 504 may function or act in a quality control role 506 or state and a failure quality issue log role 508 or state.

The warehouse management system 502 may begin by receiving inventory (step 510). As previously described the inventory may include individual electronic devices, batches of electronic devices, or other assorted or group inventory.

Next, the quality control application 504 in the quality control role 506 performs acceptable quality level and consumer private information sampling (step 512). The sampling of step 512 may be performed utilizing a single computing or communications device, or may be performed utilizing multiple devices, systems, or equipment, and their respective custom software configurations. If the received inventory passes the AQL and CPI sampling, the warehouse management system 502 may perform a receiving/putaway for all or portions of the inventory and perform subsequent processing.

Next, the quality control application 504 performs a validation workflow (step 514). In one embodiment, the validation of step 514 may be performed in a loop. The validation workflow may be a process that is performed for each failure. For example, for each failure, the validation workflow may kick back the failed unit and create an audit trail.

Depending on the results of the validation workflow and step 514. The quality control application 504 generates a failure record (step 516). The failure record may be generated utilizing automatically compiled data and information, and utilizing feedback and instructions from a user. The failure record may be generated for an individual fallout/failure of a device or a lot of devices. For example, during step 514, the quality control application 504 may determine whether a lot rejection threshold is met. For example, if the lot rejection threshold is met, the failure record generated during step 516 may be for an entire lot.

Next, in response to the failure record of step 516, the quality control application 504 in the failure quality issue role 508 logs quality issues (step 518). The quality issues may be saved in a database linked with our accessible by the quality control application 504. Next, the quality control application 504 performance workflow-based guidance in response to a lot rejection (step 520). During step 520, a return merchandise authorization may be generated for a single device or for the lot as previously described. For example, if approval is given to fail an entire lot by a service provider, supervisor, or other party, the return merchandise authorization may be generated for the lot during step 520.

The quality control application 504, then auto creates carton labels (step 522). Next, the warehouse management system 502 ships out the unit (step 524). The unit may be a single, electronic device, a lot, or any portion of inventory. The quality control application 504 then record shipping information in the failure quality issue log (step 526). The shipping information may be stored within a failure record automatically or in response to user input.

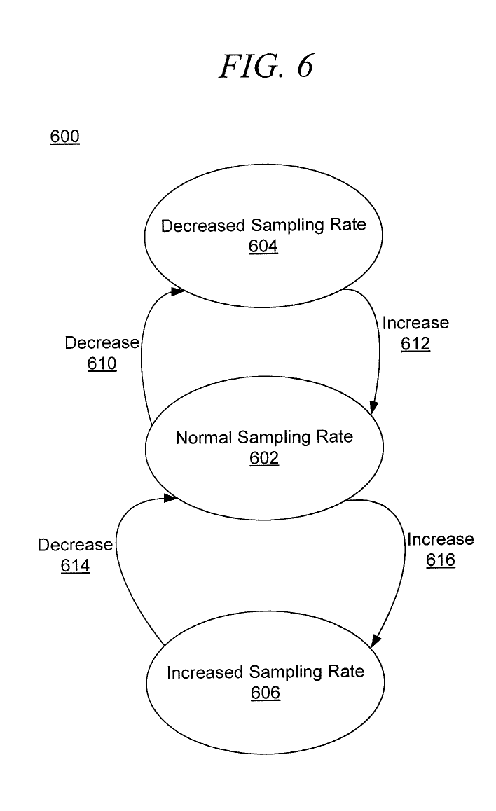

FIG. 6 is a state diagram 600 of a sampling rate in accordance with an illustrative embodiment. The transitions between the states of the state diagram 600 of FIG. 6 may be implemented by an RQIL system and in response to any number of manually entered or automatically determined thresholds, boundaries, feedback, business rules, criteria, conditions, or user input. In one embodiment, the state diagram 600 may be implemented by logic (hardware or software). The RQIL system may implement sampling in response to one of the states determinable from the state diagram 600. In one embodiment, the state diagram 600 and the associated logic may be viewable by one or more operators and administrators of the RQIL system and hidden from the applicable client. For example, the sampling thresholds, data, and associated interface pages may not be viewable by a communication service provider for whom a logistics provider performs the sampling, testing, and processing of electronic devices.

In one embodiment, the state diagram 600 includes a normal sampling rate 602, a decrease sampling rate 604, and an increased sampling rate 606. The sampling rates of the state diagram 600 may vary according to the type of electronic device, associated communications service provider, historical problems with the devices, applicable business rules, agreements, or quality controls, and any number of other factors. The threshold of the sampling rate 602 may be determined in absolute terms or as a percentage (e.g. 1 unit, 10 units, 1%, etc) relative to a sample period (e.g. a single shipment, a single lot, a single day, a single month, etc). In other embodiments, the state diagram 600 may include numerous states, each of which corresponds to a sampling rate. The sampling rates of the state diagram 600 may correspond to testing procedures and processes performed for individual or lots of electronic devices. For example, during each of the states RF testing, functional and cosmetic testing, and CPI testing may be performed. Repeated successful passes may allow the sampling rate to decrease, whereas one or more failures may result in the sampling rate being increased. In one embodiment, the sampling rate 604 may be a percentage or number of devices that are processed. For example, the normal sampling rate 602 may be 10% or 10 random devices from a lot of 100, the decreased sampling rate 604 may be 3% or 3 devices from the lot of 100, and the increased sampling rate 606 may be 25% or 25 devices of the same lot.

In one embodiment, the default state of the RQIL system is associated with the normal sampling rate 602. In one embodiment, the normal sampling rate 602 transitions to the decreased sampling rate 604 in response to successful testing of 10 lots of electronic devices (step 610). The decreased sampling rate 604 is utilized to save time. For example, operators may not need to test as many electronic devices because the control processes are working effectively.

When in the state corresponding to decreased sampling rate 604, a transition may occur in response to a failure or error at which point the RQIL system transitions or increases (step 612) to the normal sampling rate 602. In another embodiment, a failure, such as detecting CPI, may automatically transition the state and corresponding sampling rate to the increased sampling rate 606 whether from the normal sampling rate 602 or the decreased sampling rate 604. For example, in response to detecting CPI while utilizing the normal sampling rate 602, the sampling rate is increased (step 616) to the increased sampling rate 606. The RQIL system may transition or decrease (step 614) the sampling rate from the increased sampling rate 606 to the normal sampling rate 602 in response to successfully testing a specified number of lots.

In one embodiment, the RQIL system may update the thresholds for transitioning between the normal sampling rate 602, the decrease sampling rate 604, and the increased sampling rate 606 in real-time to prevent unwanted consequences of processing unsafe products. For example, in response to receiving a selection by an administrator to increase the normal sampling rate 602, lots that are being tested by operators may begin utilizing a 15% sampling rate for their associated lots. The instructions to increase the sampling rate may be received internal to an organization utilizing the RQIL system or from an external source or party, such as a communications service provider that the electronic devices are being processed for.

FIG. 7 is a pictorial representation of an interface of the RQIL system in accordance with an illustrative embodiment. The interface 700 is one embodiment of a graphical user interface, such as a webpage of a browser or other application. The interface 700 may include any number of fields, buttons, icons, hyperlinks, query fields, drop-down lists and menus, titles, calendars, or other indicators or selection elements. In one embodiment, all or portions of the interface 700 may be displayable to a party in response to permissions set for each party. For example, a logistics provider may provide redacted information regarding testing and procedures and allow a communications service provider to provide input and adjust the workflow as needed. The interface 700 may be configured to separate information for distinct clients, suppliers, call centers, repair centers, communications service providers, retail providers, logistics providers, and other interested parties.

In one embodiment, the interface 700 allows a user to configure information for a supplier in the RQIL system. The interface 700 may guide the user through any number of steps or tasks which may include: creating an organization (supplier), creating a supplier administrator role, creating a supplier administrative user, adding one or more e-mail addresses associated with the supplier, creating a distribution list, and assigning notifications to the distribution lists. In one embodiment, the information for the supplier is configured to provide access and notifications regarding functions and reporting for the RQIL system.

In addition, any of the parameters, criteria, thresholds, tests, instructions, or other input may be received through interactive elements and fields of the interface 700.

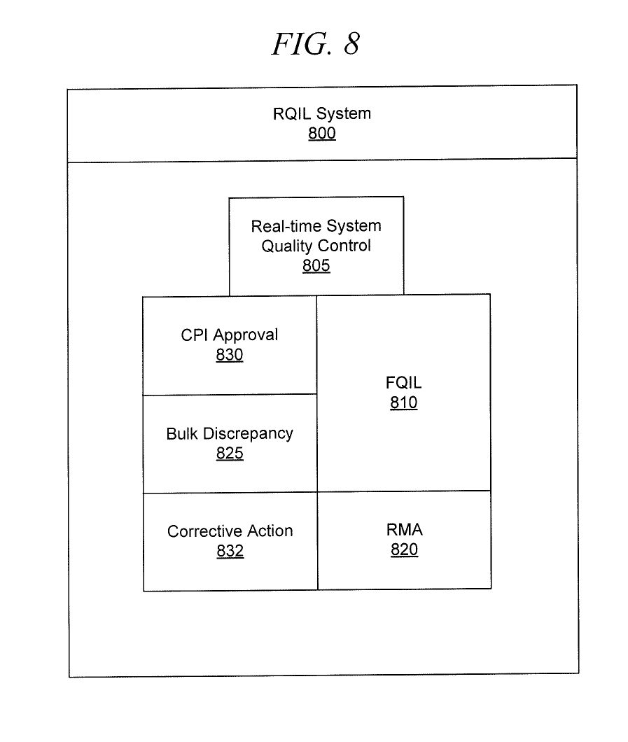

FIG. 8 is a block diagram of modules of the RQIL system 800 in accordance with an illustrative embodiment. The modules of the RQIL system 800 may be utilized to perform the processes of FIGS. 3-6. The modules may also correspond to portions of the interface or application that guide an operator or user through processing of electronic devices. As a result, the modules may include both steps, interfacing components, and logic for implementing the processes of the RQIL system 800. The RQIL system 800 provides a web-based solution with role-based workflow of quality control operations for customer, supplier, and warehouse users.

The web interface provides workflow-based functionality relating to the inspection, rework, and return operations for inbound products in XBM and bulk receiving operations. The RQIL system 800 provides role-based security to restrict access to modules or individual records (i.e.restrict suppliers ability to view records other than their own). The details of the modules of the RQIL system 800 are described individually as a way to further describe the requirements and functional components and is not intended to present the modules and stand-alone operations or programs, but as a portion of an end-to-end system that shares code, data, and configurations were appropriate.

A real-time system (RTS) quality control (QC) module 805 may be utilized to perform the general processing of the electronic devices. In one embodiment, the RTS QC module may be implemented to initiate processing of electronic devices. For example, a truck may be unloaded into a pulling area to separate exchange by mail (XBM) units from bulk receiving (each may take a slightly different path).

The XPM product entering the warehouse may be subjected to quality-control sampling via the RQIL system. Failures driven out through this process may either be lot rejected or individual unit failures (commonly referred to as fallout) which may be managed by separate modules, but are shown herein as being managed by the FQIL module 810. Lot rejections may be entered into the FQIL 810. The Lot rejections may be tracked from initial entry through the return and exchange of product to/from the supplier, to the final root cause analysis and corrective action(s) performed by the supplier and approved by a communications service provider. The RQIL system allows individual failures to be sent through the FQIL module 810 as well to more efficiently perform processing. The RTS QC module 805 and the FQIL module 810 have significant common data elements that combine information from both systems into a single report.

In the RTS QC module 805, product arriving through the bulk receiving process is sampled for quality various systems and controls, such as those incorporated by reference. Individual and lot failures may be driven by a set of discrepancy codes that identify the root issue and that determine whether a lot or individual piece is rejected, further sampled, or reworked. In each potential scenario, a discrepancy ticket maybe opened and tracked through the same stages as an FQIL ticket, return and exchange of product to/from the supplier, to the final root cause analysis and corrective action performed by the supplier and approved by the communications service provider. In one embodiment, the RQIL system 800 may provide a serial workflow and a web interface to this process. A RMA module 820 which includes an RMA workflow, tracking, and reporting is available to both the FQIL XBM Fallout module, FQIL Lot Rejection module, and Bulk Discrepancy module 825. Additionally, RMA requests do at times originate from outside of the quality process. Relevant examples may include a vendor recall of a product or stock buy back. As a result, it may be necessary to provide a web interface that allows authorized users to submit an RMA request through the RMA module 820 and specifics that may be tracked in the system. By consolidating the RMA information in the RQIL system 800, rollup reporting may occur that is inclusive of RMAs issued through XBM for quality issues and through bulk for discrepancy and customer generated nondiscrepancy RMAs.

The RQIL system 800 may provide serial workflow with aging and notifications. In one embodiment, the RQIL system uses a serial workflow process. In each case as a key milestone in the process is met and control is transferred to a different user/role a status change may occur with an email notification being sent to the appropriate parties based on distribution center, supplier and customer organization (i.e. DSL or Mobility). The ticket may then be placed in that user/role's queue. For example, if a warehouse user entered a FQIL ticket, an email alerting the communications service provider and the specific supplier from the distribution lists maybe be sent. In addition, the manufacturers, vendors, associated carriers, and other providers may also be notified. If supplier logged into FQIL module 810, the supplier may be able to see a list of all FQIL tickets sorted by status, including those tickets with a status requiring an action by the supplier.

In addition to notifications, the RQIL system 800 may allow configured aging and notification for each process in the workflow of the received electronic devices. For example, if a supplier has a request for a root cause analysis update to be performed for an FQIL ticket and that action is configured as 30 days in a setup table with a 7 day reoccurring alert then at 30 days after the ticket was routed to supplier for root cause analysis, an email notification may alert the supplier that root cause analysis is overdue and continue to alert the supplier every 7 days until the root cause analysis is performed.

The RQIL system 800 provides enhanced audit tracking. For example, an audit trail history is generated for each ticket while the interface to the RQIL system 800 allows all changes throughout the ticket lifecycle to be viewed by authorized parties. The RQIL system 800 also provides policy-based approvals. In one embodiment, for each status change the RQIL system 800 provides a policy/setup configurable option for approval. Approvals may have presumed initial values. For example, approval making include one or more ticket assignments to a configured approver (i.e. supplier of a communications service provider) with notification and aging. Valid actions may be approved or rejected and updates may be made to any/all fields of the tickets. Any updated fields may change workflow operations in a next stage of the workflow but may not to be evaluated for historical actions. Approval of the action moves the ticket forward in the workflow with a rejection returning ticket to previous status and owner/responsible party. The RQIL system 800 may transfer responsibility between any number of operators are parties accessing the RQIL system 800 locally or remotely. For example, control transfer points may specify which module, interface pages, track, and process steps of the workflow are implemented by the RQIL system 800.

The RQIL module 810 provides a role-based validator to validate failures before a failure record is finalized. The CPI approval module 830 provides approval for CPI defects. In one embodiment, because of the financial impact, the communications service provider requires approval of CPI defects. For example, defects, such as CPI are classified or reclassified according to the associated failure type. In one embodiment, reclassing a CPI error into a different failure type may result in the loss threshold for this error type being exceeded. If this occurs, the RTS QC module 805 recognizes and handles a lot rejection process.

The RQIL system 800 may generate any number of reports. The reports may be customized, filtered, viewable, and exportable in any number of formats including CSV, Excel, HTML, etc. in one embodiment the RQIL system 800 generates a summary report with headers with particular detail lines associated with the model of electronic device. Examples of headers include Supplier, total units, and units audited from supplier. Detail items may include unit type, total lot size, total audited, total past, total failed, percentage failed, failure type (i.e. cosmetic (COS), customer personal information (CPI), functional (FCT), default content (DFT), radio frequency (RF). The RQIL system 800 may also provide a summary report for failures with the ability to drill down or narrowed details for a single failure area or by default include all areas. The failure report may list column headings including OEM, Ttl Inspected, Ttl Failures, Failure %, COS, COS % Kitting, COS Kitting, KOS %, CPI, CPI %, FCT, FCT %, Factory DFT, Factory DFT %, RF, RF %, Ttl Lots, Qty Failed, Lots, Lot Failure %, and QC Lot.

The failure report may be selectable by OEM (or all) by date range and by failure code (or all). Data elements may include FQIL #, Date, IMEI, OEM, Vendor, RTS#, Model #, Part #, Load #, Failure Code Description of Failure, and RMA#. The RQIL module 810 may perform field mapping for new data elements. In one embodiment, the SQL module automatically generates reports replacing manual entry of information. The RMA module 820 may be utilized to receive RMA input from the supplier in response to the SQL ticket.

The SQL module 810 additionally provides unit failure reporting. For example, the records may include individual unit failures that were not part of a lot rejection. These individual failures are typically referred to as fallout by operations and customers. The reports for individual failures may include data elements, including FQIL#, IMEI, Model#, Part#, Receipt, RTS #, Returned RTS #, Failure Code, Failure Description, and RMA#.

The RQIL system 800 may provide reports detailing RF testing. The RF testing reports may be selectable by a supplier and date range to display details of RF failures. In one embodiment, the RF reporting may log details of the applicable RF failures including IMEI, Model, SKU, TITLE, Measured Value, and Test Category. Lower/Upper Limits, (Unit of Measure).

The RQIL system 800 provides functionality for generating the SQL tickets. In one embodiment, once the RTS QC sampling loop performed by the RTS QC module 805 is completed for an item, a fallout or lot rejection SQL ticket is generated and assigned to a warehouse role, user, or operator for additional input. The RQIL system 800 also auto populates SQL tickets with relevant information. The RQIL system 800 provides capabilities to determine the state of each lot or individual unit being evaluated and process. For example, the RQIL system 800 may include the ability to initiate a corrective action request and an interface to select a make and model from a menu, add a model from a submission screen, select and update a trouble indicator form a submission screen. The RQIL system and hundred may also provide the operator the ability to view issues many number of formats, including a paginated list of historical issues, a filtered list by supplier, a CAR specific screen from a view screen, from the CAR specific screen and information update page by role.

In another embodiment, the RQIL system 800 may allow an administrator to maintain values for a drop-down list available through the interface, including a make/model matrix, severity levels, defect types, trouble indicated, and detection. The interface may also allow an administrator to set up user accounts including a username, real name, phone, e-mail, team, and notification permissions and preferences.

The interface may also provide the administrator or other operator the ability to view and manage teams. For example, utilizing the interface of the RQIL system a user may provide setup to create a team entity, assign a user to a team, view a team members as a group with associated notification flex, and set notification flex on a team screen. The interface may also provide e-mail notifications for individual or team distribution when a CAR is initiated or updated, and lists for all effective teams (i.e. when a new CAR is created submitting 18, the communications service provider and affected supplier teams may all receive e-mail to their respective distribution lists). The interface may also be utilized to assign and manage roles. Roles may be used used to manage access to view or edit certain parts of the CAR. For example, initial roles may include a warehouse role for initiating corrective action requests and viewing all corrective action requests, an OEM role for viewing associated CARS and editing the OEM specific sections of the Car, and an administrative role having all available access and functionality. Similarly, the interface may divide that the functionality and modules of the RQIL system 800 by a warehouse, OEM, and administrative specific roles.

The RQIL system 800 may allow users to treat failures as fallout rather than lot rejections. For example, in response to determining a lot has one or more failures the remaining stock may be inspected 100% instead of feeling the entire lot. The RMA module 820 may provide and RMA workflow for lot rejection. For example, if lot rejection is approved by a customer then the supplier sends a request for RMA information. Once the supplier enters the RMA information, a route ticket may be received by a warehouse user/role for input of carrier tracking information. As a result, the RQIL system 800 provides tracking information and workflow for lot failure or fallout.

The RMA module 820 may also provide efficiencies for processing fallout. In one embodiment fallout returns are sent once a week in order to reduce shipping and handling costs rather than an immediate return that may occur due to lot failure. For example, at a defined interval rollup of all individual fallout items by supplier and by SKU may be processed with a master RMA request to the supplier. Supplier then enters one RMA which may update all affected individual tickets.

The RQIL system 800 also provides tracking for XPM fallout. In one embodiment, once the supplier updates the master RMA information for rollup fallout, a warehouse user may be required to enter tracking information for the shipment. As previously described, the user may be able to enter master information that updates all affected tickets. The RMA and tracking information may also be updated for individual fallout tickets (in particular when the lot rejection threshold is not met). In one embodiment if such an update is performed prior to the time of rollup, the affected tickets will be excluded from the master update.

A corrective action module 832 may provide a corrective action workflow and process. In one embodiment, the corrective action loop may begin once a warehouse user enters shipping tracking information for a product. The supplier may be required to update root cause and corrective action sections of the FQIL ticket with the communications service provider approving the information before the ticket is closed. If the communications service provider rejects a corrective action or root cause analysis, then the supplier may be required to update information to meet the communications service provider's approval. The F2. I help module 810 may allow a user to attach a picture, video, or other file to the SQL ticket

In one embodiment, the RQIL system 800 provides discrepancy ticket functionality. For example, the interface may display a discrepancy ticket and report including fields, and other information, such as a discrepancy number that is unique to that ticket and unit. The RQIL system 800 may be managed from a master page or dashboard and may include pages dedicated to each of the modules and sub-modules and associated processes and workflows as are herein described.

The RMA module 820 may provide rollup RMA reporting. For example, the RMA report may be selectable by DC, OEM, date range, and origin (i.e. FQIL, Discrepancy, Non Discrepancy RMA).

The previous detailed description is of a small number of embodiments for implementing the invention and is not intended to be limiting in scope. The following claims set forth a number of the embodiments of the invention disclosed with greater particularity.

What is claimed:

1. A computer implemented method for managing quality processing of electronic devices, the method comprising:
receiving a plurality of electronic devices for processing;
randomly sampling the plurality of electronic devices utilizing sampling thresholds to determine issues with the plurality of electronic devices;
automatically adjusting the sampling thresholds in real-time in response to results of the sampling;
implementing failure processing in response to one or more of the plurality of electronic devices failing the sampling; and
recording information associated with the processing of the plurality of electronic devices in one or more databases.

2. The method according to claim 1, wherein the plurality of electronic devices are received in lots for processing.

3. The method according to claim 1, further comprising:
distributing the plurality of electronic devices to a plurality of operators for testing, wherein the distribution is recorded.

4. The method according to claim 1, wherein the failure processing includes at least:
sending an alert to a distribution list in response to the one or more of the plurality of electronic devices failing the sampling.

5. The method according to claim 1, wherein the failure processing further comprises:
returning the plurality of electronic devices.

6. The method according to claim 1, further comprising:
creating a ticket; and
generating root cause analysis for each ticket associated with a failure.

7. The method according to claim 6, further comprising:
receiving updates to the ticket; and
automatically sending notifications to a distribution list associated with the ticket each time the ticket is updated.

8. The method according to claim 1, wherein the automatically adjusting comprises:
increasing the sampling threshold in response to one of the plurality of electronic devices failing the sampling.

9. The method according to claim 1, wherein the automatically adjusting comprises:
decreasing the sampling threshold in response to sampling a designated number of the plurality of electronic devices without any of the plurality of electronic devices failing the sampling.

10. The method according to claim 1, wherein the sampling comprises:
performing testing including radio frequency, cosmetic, and consumer private information tests on each of the plurality of electronic devices.

11. A system for managing quality processing of electronic devices, the system comprising:
one or more client devices configured to receive information for a plurality of electronic devices for processing;
a server configured to create tickets for each of the plurality of electronic devices, manage random sampling of the plurality of electronic devices utilizing sampling thresholds, automatically adjust the sampling thresholds in real-time in response to results of the sampling, and implement failure processing in response to one or more of the plurality of electronic devices failing the sampling; and
a database in communication with the server, the database configured to store the information associated with each of the tickets for each of the plurality of electronic devices.

12. The system according to claim 11, wherein the random samplings includes performing testing including radio frequency, cosmetic, and consumer private information tests on each of the plurality of electronic devices.

13. The system according to claim 11, wherein the server sends a notification to a distribution list associated with each of the tickets in response to the one or more of the plurality of electronic devices failing the sampling or receiving an update to one of the tickets.

14. The system according to claim 11, wherein the server increases the sampling threshold in response to one of the plurality of electronic devices failing the sampling and decreases the sampling threshold in response to sampling a designated number of the plurality of electronic devices without any of the plurality of electronic devices failing the sampling.

15. The system according to claim 11, wherein the server generates root cause analysis for each ticket associated with a failure.

16. A server comprising:
a processor for executing a set of instructions; and
a memory for storing the set of instructions, wherein the set of instructions are configured to:
receive a plurality of electronic devices for processing;
generate one or more tickets for the plurality of electronic devices;
randomly sample the plurality of electronic devices utilizing sampling thresholds to determine issues with the plurality of electronic devices;
automatically adjust the sampling thresholds in real-time in response to results of the sampling;
implement failure processing in response to one or more of the plurality of electronic devices failing the sampling; and
record the one or more tickets including information associated with the processing of the plurality of electronic devices in one or more databases.

17. The server according to claim 16, wherein the random samplings includes performing testing including radio frequency, cosmetic, and consumer private information tests on each of the plurality of electronic devices.

18. The server according to claim 16, wherein the set of instructions further:
send a notification to a distribution list associated with each of the one or more tickets in response to the one or more of the plurality of electronic devices failing the sampling or receiving an update to the one or more tickets.

19. The server according to claim 16, wherein the set of instructions further:
generate root cause analysis for each ticket associated with a failure.

20. The server according to claim 16, wherein the set of instructions further:
display an interface for displaying information to a plurality of parties in response to permissions for the plurality of parties.
